(19) United States
(12) Patent Application Publication
(10) Pub. No.: US 2008/0007449 A1
(43) Pub. Date: Jan. 10, 2008

(54) Radar Sensor

(76) Inventor: Thomas Focke, Ahrbergen (DE)

Correspondence Address: KENYON & KENYON LLP, ONE BROADWAY, NEW YORK, NY, 10004, US

(21) Appl. No.: 10/579,255

(22) PCT Filed: Oct. 12, 2004
(86) PCT No.: PCT/EP04/52507

§ 371 Date: May 7, 2007

(30) Foreign Application Priority Data
Dec. 6, 2003 (DE) 103 57 148.5

(51) Int. Cl. G01S 13/00; G01S 7/40

(52) U.S. Cl. 342/165; 342/175

(57) ABSTRACT

A first receiving antenna having a broad antenna characteristic and a second receiving antenna having a narrow antenna characteristic are provided in a radar sensor utilizing the pulse-echo principle. A switching between the receive signals of both receiving antennas at the clock pulse of the pulse repetition frequency of the transmitted radar pulses takes place in the receiving path.

### FIELD OF THE INVENTION

The present invention is directed to a radar sensor using the pulse-echo principle and having at least two receiving antennas.

### BACKGROUND INFORMATION

For determining angle offset, Skolnik's “Introduction to Radar Systems,” 2^{nd} Edition, McGraw-Hill Book Company, 1980, pages 160 to 161, describes analyzing two overlapping antenna characteristics when a mono-pulse radar is used.

A pulse radar system having multiple receiver chains is described in published German patent document DE 101 42 170. Multiple receiving cells may be analyzed simultaneously and/or a switch may be made between different modes of operation.

### SUMMARY

In accordance with the present invention, a first receiving antenna having a broad short-range antenna characteristic and a second receiving antenna having a narrow long-range antenna characteristic are provided, and a switching between the receive signals of both receiving antennas at the clock pulse of the pulse repetition frequency of the transmitted radar pulses is provided in the receiving path. In addition, it is possible to obtain angle information from the entire radar sensing field, using the combination of mono-pulse and triangulation methods.

This arrangement provides an improved differentiation between useful targets and erroneous targets.

A calibration is easily achieved by obtaining redundant information when combining two radar sensors.

### BRIEF DESCRIPTION OF THE DRAWINGS

FIG. 1 shows a block diagram of a conventional radar sensor.

FIG. 2 shows a block diagram of a radar sensor according to the present invention.

FIG. 3 shows antenna characteristics of two dual-beam sensors for covering a driving corridor.

### DETAILED DESCRIPTION

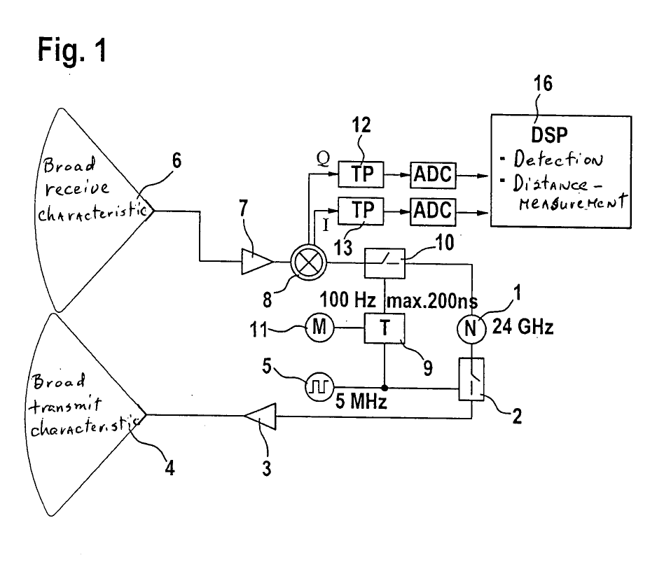

FIG. 1 shows a block diagram of a conventional radar sensor. The radar sensor has a high frequency source 1 which delivers a continuous high frequency signal of 24 GHz (Cw signal), for example. This high frequency signal reaches a transmit-side pulse modulator 2 for generating a radar pulse and, via an amplifier 3, reaches transmitting antenna 4 having a broad short-range antenna characteristic. Pulse modulator 2 is controlled via a rectangular signal 5 of 5 MHz. Using radar receiving antenna 6, which also has a broad antenna characteristic, the radar pulses, reflected from a radar target, are received and supplied to a quadrature mixer 8 via a reception pre-amplifier 7. Due to the fact that rectangular signal 5 switches receive-side pulse modulator 10 in a delayed manner via time delay element 9 with a delay of maximal 200 ns, the quadrature mixer receives the temporally delayed transmission pulses at its LO input.

Only when the pulse propagation time to the target and the delay time of the carrier pulses correspond at quadrature mixer 8 does a mixed product result at the NF port (IQ outputs), i.e., a temporal windowing is implemented using the adjustable delay time, the windowing linked via the propagation rate of electromagnetic waves being equivalent to a distance measurement. If the delay time is varied according to a saw tooth function, using a saw tooth voltage generator 11, it is possible to systematically scan the distance for possible targets. If this scanning takes place relatively slowly in relation to the pulse repetition rate, multiple pulses (typically several hundred) are received per target and integrated for improving the signal-to-noise ratio using low pass filters 12, 13. Subsequently, an analog-to-digital conversion (ADC) takes place in steps 14 and 15, as well as a corresponding digital signal processing (DSP) including detection and distance measurement in module 16.

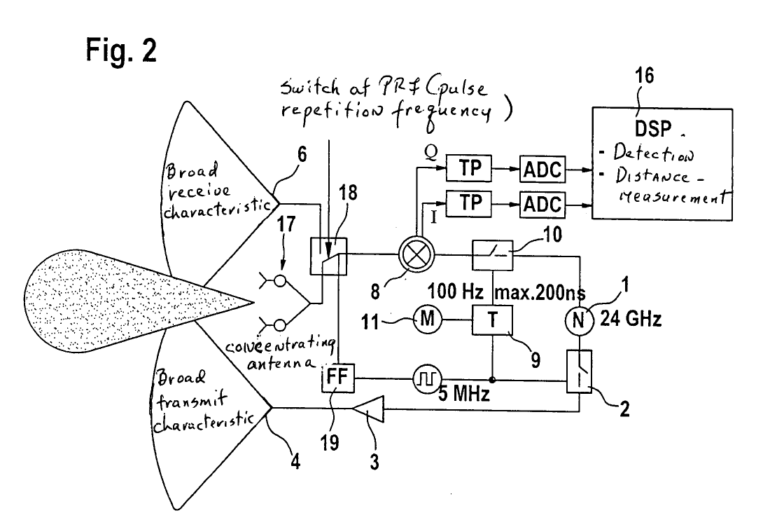

A dual-beam sensor is shown in FIG. 2 as an exemplary embodiment according to the present invention. The sensor of FIG. 2 differs from the sensor of FIG. 1 in having a receiving antenna 17 and a transfer switch 18. The antenna 17 is a heavily concentrating antenna for the long range and has a higher performance in the main beam direction, which makes it possible to detect targets at a greater distance (provided the distance window is delayed up to the maximum distance).

Furthermore, the system is expanded by a transfer switch 18 in combination with a bistable flipflop 19 which alternatingly transmits the HF signal energy from the two antennas to mixer 8, e.g., at the pulse repetition clock rate of the transmitted radar pulses, i.e., only half as many pulses are received per receiving antenna. Low pass filters 12, 13 upstream from analog-to-digital converter ADC may not have an integrating effect, but are rather only used as anti-aliasing low pass filters for band limitation. To that effect, the ADC should have a higher sample rate. The ultimate pulse integration for each antenna path takes place digitally in processor 16. The evident disadvantage of the integration loss of 3 dB may be compensated at least in part, since the NF signals of the two reception paths of a ramp passage may be totaled in processor 16 for the detection, thereby reaching the signal-to-noise ratio of the original sensor for targets detected by both antennas. However, an integration loss of 3 dB occurs if a target is located outside the sensing area of the narrow antenna.

The switch over is active as long as the short range of the sensor (corresponds to the broad reception characteristic) is being scanned. Using the known mono-pulse method, an angle determination is also possible in the area in which both antenna characteristics overlap. The angle determination methods are not discussed in greater detail. A switch over is no longer expedient from a certain scanning distance, since only targets having the long range characteristic are detected.

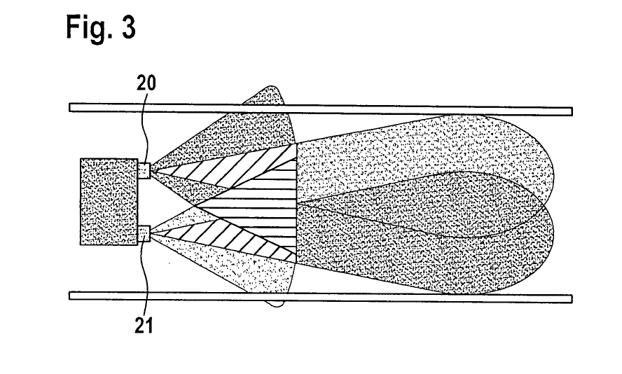

If two or optionally three dual-beam sensors are used, an angle determination is possible in the entire target corridor by combining the mono-pulse and triangulation methods. FIG. 3 shows the coverage of the target corridor by two dual-beam sensors 20 and 21. The hatched areas indicate the overlapping areas.

In the areas in which the antenna characteristics of the two antennas of one sensor overlap, the target angle is determined using the mono-pulse method, and the triangulation method is used for the angle determination in the areas in which the characteristics of both sensors overlap. Redundant information which may be used, for example, for a simple calibration of the mono-pulse analysis, is obtained in the short range (i.e., by using overlapping of four antenna characteristics).

1-4. (canceled)

5. A radar sensor utilizing the pulse-echo principle, comprising:
a first receiving antenna having a broad short-range antenna characteristic;
a second receiving antenna having a narrow long-range antenna characteristic; and
a switch coupled to the first and second receiving antennas, wherein the switch alternatingly transmits a received signal of the first receiving antennas and a received signal of the second receiving antenna by switching between the first and second receiving antennas at a pulse repetition frequency of radar pulses transmitted by a transmitting antenna.

6. The radar sensor as recited in claim 5, wherein the switching takes place only within a scanning distance range corresponding to the short-range antenna characteristic.

7. A radar system, comprising:
at least two radar sensors, each radar sensor including:
a first receiving antenna having a broad short-range antenna characteristic;
a second receiving antenna having a narrow long-range antenna characteristic; and
a switch coupled to the first and second receiving antennas, wherein the switch alternatingly transmits a received signal of the first receiving antennas and a received signal of the second receiving antenna by switching between the first and second receiving antennas at a pulse repetition frequency of radar pulses transmitted by a transmitting antenna;
wherein a target angle determination is achieved in the short range by superimposing the short-range and long-range antenna characteristics of one radar sensor according to the mono-pulse method, and wherein a target angle determination is achieved in the long range by triangulation using the at least two radar sensors.

8. A radar system, comprising:
at least two radar sensors, each radar sensor including:
a first receiving antenna having a broad short-range antenna characteristic;
a second receiving antenna having a narrow long-range antenna characteristic; and
a switch coupled to the first and second receiving antennas, wherein the switch alternatingly transmits a received signal of the first receiving antennas and a received signal of the second receiving antenna by switching between the first and second receiving antennas at a pulse repetition frequency of radar pulses transmitted by a transmitting antenna, and wherein the switching takes place only within a scanning distance range corresponding to the short-range antenna characteristic;
wherein a target angle determination is achieved in the short range by superimposing the short-range and long-range antenna characteristics of one radar sensor according to the mono-pulse method, and wherein a target angle determination is achieved in the long range by triangulation using the at least two radar sensors.

9. The radar system as recited in claim 7, wherein a calibration of the at least two radar sensors is achieved by obtaining redundant information in areas where the first antenna of a first sensor, the second antenna of the first sensor, the first antenna of a second sensor, and the second antenna of the second sensor overlap.

10. The radar system as recited in claim 8, wherein a calibration of the at least two radar sensors is achieved by obtaining redundant information in areas where the first antenna of a first sensor, the second antenna of the first sensor, the first antenna of a second sensor, and the second antenna of the second sensor overlap.
